(19) United States
(12) Patent Application Publication
(10) Pub. No.: US 2016/0227228 A1
(43) Pub. Date: Aug. 4, 2016

(54) VIDEO CAMERA WITH LAYERED ENCODING, VIDEO SYSTEM AND METHODS FOR USE THEREWITH

(71) Applicant: ViXS Systems, Inc., Toronto (CA)

(72) Inventors: John Pomeroy, Markham (CA); David Michael Brass, Center Valley, PA (US)

(73) Assignee: ViXS Systems, Inc., Toronto (CA)

(21) Appl. No.: 14/609,119

(22) Filed: Jan. 29, 2015

(51) Int. Cl. H04N 19/187; H04N 9/82; H04N 9/87; H04N 19/44; H04N 5/232

(52) U.S. Cl. CPC H04N 19/187; H04N 19/44; H04N 5/23245; H04N 9/87; H04N 9/8227

(57) ABSTRACT

Aspects of the subject disclosure may include, for example, a video camera that includes a video capture device configured to produce a high resolution video signal. A video encoder is configured to layered video encode the high resolution video signal to generate a processed video signal, the processed video signal including a plurality of independent video layers, each of the plurality of independent video layers having a different video resolution. Other embodiments are disclosed.

### TECHNICAL FIELD OF THE DISCLOSURE

The present disclosure relates to coding used in devices such as video cameras.

### DESCRIPTION OF RELATED ART

Video cameras have become prevalent consumer goods. Not only do many consumers own a standalone video camera, but most consumers own devices such as smartphones, laptop computers or tablets that include a video camera. Captured video can be encoded for transmission or storage.

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including the H.264 standard that is also referred to as MPEG-4, part 10 or Advanced Video Coding, (AVC). While this standard sets forth many powerful techniques, further improvements are possible to improve the performance and speed of implementation of such methods. Further, encoding algorithms have been developed primarily to address particular issues associated with broadcast video and video program distribution.

Further limitations and disadvantages of conventional and traditional approaches will become apparent to one of ordinary skill in the art through comparison of such systems with the present disclosure.

### BRIEF DESCRIPTION OF THE SEVERAL VIEWS OF THE DRAWINGS

FIG. 1 presents pictorial diagram representations of various devices in accordance with embodiments of the present disclosure.

FIG. 2 presents a block diagram representation of a video camera 102 in accordance with an embodiment of the present disclosure.

FIG. 3 presents a temporal diagram representation of a processed video signal in accordance with an embodiment of the present disclosure.

FIG. 4 presents a block diagram representation of a video system 360 in accordance with a further embodiment of the present disclosure.

FIG. 5 presents graphical diagram representations of screen displays in accordance with an embodiment of the present disclosure.

FIG. 6 presents a flowchart representation of a method in accordance with an embodiment of the present disclosure.

FIG. 7 presents a block diagram representation of a video camera 102′ in accordance with an embodiment of the present disclosure.

FIG. 8 presents a block diagram representation of a metadata processor 125 in accordance with an embodiment of the present disclosure.

### DETAILED DESCRIPTION OF THE DISCLOSURE INCLUDING THE PRESENTLY PREFERRED EMBODIMENTS

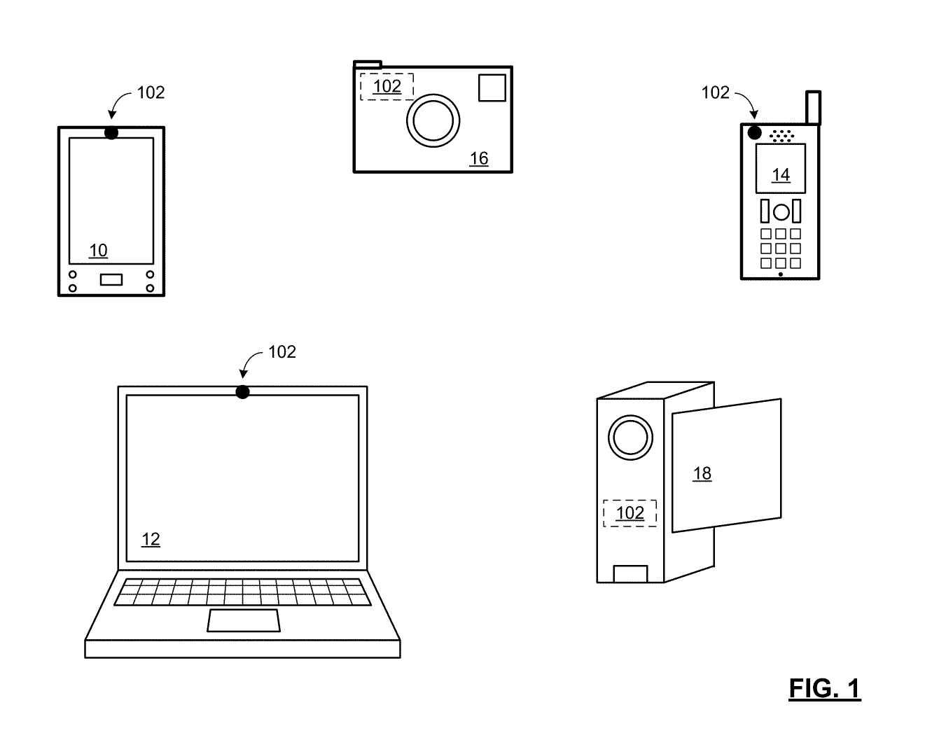

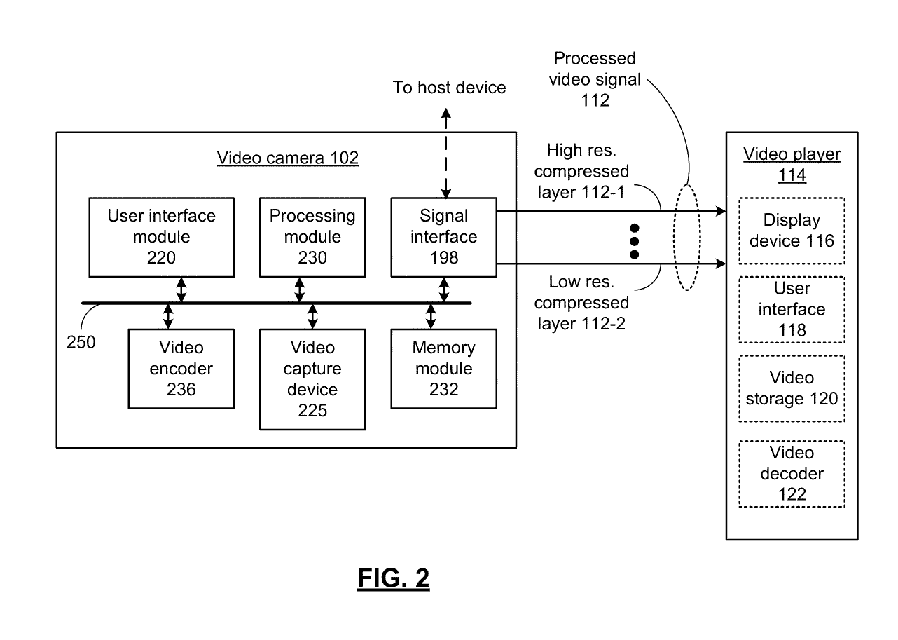

FIG. 1 presents pictorial diagram representations of various video devices in accordance with embodiments of the present disclosure. In particular, digital video camera 18, along with tablet 10, laptop computer 12, smartphone 14, and digital camera 16 illustrate electronic devices that incorporate a video camera 102 that includes one or more features or functions of the present invention. While these particular devices are illustrated, video camera 102 includes any device that is capable of generating processed video signals in accordance with the methods and systems described in conjunction with FIGS. 2-6 and the appended claims.

FIG. 2 presents a block diagram representation of a video camera 102 in accordance with an embodiment of the present disclosure. In particular, video camera 102 includes a signal interface 198, a user interface module 220, a video capture device 225, a processing module 230, a memory module 232, and a video encoder 236.

The video capture device 225 includes a lens and digital image sensor such as a charge coupled device (CCD), complementary metal oxide semiconductor (CMOS) device or other image sensor that produces a high resolution video signal. As used herein, high resolution means resolution that is higher than a standard definition (SD) video signal. Optional user interface module 220 includes one or more buttons, a touch screen, and/or other user interface device that operates under the control of the user to generate one or more signals that indicate user commands.

The video encoder 236 is configured to layered video encode the high resolution video signal to generate a processed video signal 112 that is formatted for output via the signal interface 198. In particular, the processed video signal 112 includes a plurality of independent video layers, each of the plurality of independent video layers such as a high resolution compressed video layer 112-1, low resolution compressed layer 112-2, etc. that are, for example, mirror encoded to different video resolutions and formatted in a layered and synchronized fashion.

The plurality of independent video layers of the processed video signal 112 can each be a digital video signal in a compressed digital video format such as h.264, MPEG-4 Part 10 Advanced Video Coding (AVC), high efficiency video coding (HEVC) or other digital format such as a Moving Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary.

The processed video signal 112 may be optionally encrypted, may include corresponding audio, and may be formatted for transport via one or more container formats. Examples of such container formats are encrypted Internet Protocol (IP) packets such as used in IP TV, Digital Transmission Content Protection (DTCP), etc. In this case the payload of IP packets contain several transport stream (TS) packets and the entire payload of the IP packet is encrypted. Other examples of container formats include encrypted TS streams used in Satellite/Cable Broadcast, etc. In these cases, the payload of TS packets contain packetized elementary stream (PES) packets. Further, digital video discs (DVDs) and Blu-Ray Discs (BDs) utilize PES streams where the payload of each PES packet is encrypted.

In one example of operation, the high resolution compressed video layer 112-1 is a high efficiency video coding (HEVC) 4K or 8K signal that is compressed in accordance with the h.265 standard, and the low resolution compressed layer 112-2 is a h.264 or h.265 compressed standard definition video signal, however other compressed high resolution signals can likewise be employed. Unlike other layered video coding schemes such as scaled video coding (SVC) which include a base layer and one or more enhancement layers that require the base layer for encoding, each of the plurality of independent video layers are independently decodable without accessing any other one of each of the plurality of independent video layers.

The video player 114 includes a display device 116 such as a liquid crystal display (LCD), light emitting diode (LED) or other display device. The user interface 118 operates under the control of the user of the video player 114 to generate signals to control the video player 114 in response to the user commands. The video player 114 also includes a video storage 120 such as a memory device and a video decoder 122 that decodes a selected one of the plurality of independent video layers of the processed video signal 112 for display by the display device 116. In particular, the plurality of independent video layers are time synchronized to permit the video player 114 to switch, in real time, between playback of high resolution compressed layer 112-1 and playback of the low resolution compressed layer 112-2.

In an embodiment, the signal interface 198 includes one or more serial or digital signal interfaces. In embodiments where the video camera 102 is implemented as a component of a host device, such as laptop computer, smartphone, tablet, etc., the signal interface 198 can provide a communication path with the host device. The video capture device 225 can operate under control of user commands indicated by signals from the user interface module 220 or the host device, however, in other embodiments, such as video surveillance applications and other static video implementations, the video capture device 225 can operate independently of a user. Further, while the video camera 102 and the video player 114 are shown as separate devices, in other embodiments, the video camera 102 and the video player 114 can be implemented in the same device, such as a personal computer, tablet, smartphone, or other device.

The processing module 230 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 232. Memory module 232 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 230 and memory module 232 are coupled, via bus 250, to the signal interface 198, video capture device 225, video encoder device 236 and user interface module 220. In an embodiment of the present disclosure, the signal interface 198, video capture device 225, video encoder device 236 and user interface module 220 each operate in conjunction with the processing module 230 and memory module 232. The modules of video camera 102 can each be implemented in software, firmware or hardware, depending on the particular implementation of processing module 230. It should also be noted that the software implementations of the present disclosure can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present disclosure.

In one mode of operation, the video camera 102 operates by itself or as part of a collection of cameras that each directly output (simulcast) processed video signals 112 that each include two or more synchronized video layers with different resolutions. The low resolution compressed layer 112-2 can be used for mosaic or other composite presentation where the multiple camera views are shown together. The high resolution compressed layer 112-1 versions of each processed video signal 112 are instantly available for selection as the primary to view.

For example, in an automotive environment where a plurality of video cameras 102 are included around a vehicle, the low resolution images could be used for assembly into a so-called Bird's eye view, while the higher resolution version can recorded for storage and forensics, but can also be available to be switched to in real time with no delay when the low resolution is selected from the mosaic and that camera's video becomes the primary video for display. In video surveillance, home monitoring and security, the low resolution layer from the video camera 102 can be used for transmission to a monitoring station, while the high resolution is captured for forensics, or later review, or even local viewing.

In another example, a video editor could apply an edit list to a group of images in real time and apply the edit list to a group of high resolution files either in the background or in real time. In this fashion, a video sequence can follow one low resolution then another, then another, etc. . . . by so doing create sequence of events or follow an event taking place, but end up with one single continuous video sequence. In addition, these techniques can be used in offline editing. In particular, a low resolution time-synchronized image is used to optimize processing and use flexibility, but the high resolution version remains available to have the manipulations applied off line after the fact.

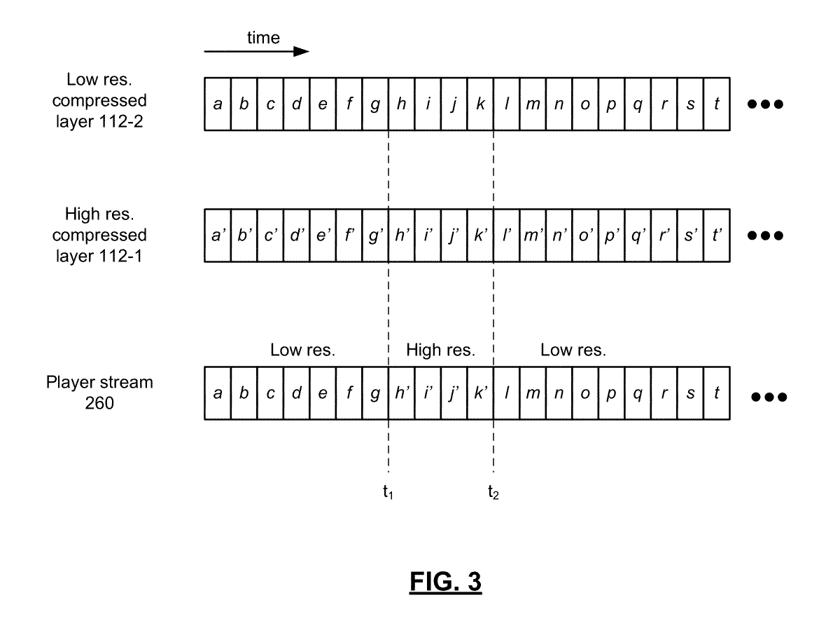

Further examples of the video camera 102 and video player 114 including several optional functions and features are presented in conjunctions with FIGS. 3-6 that follow.

FIG. 3 presents a temporal diagram representation of a processed video signal in accordance with an embodiment of the present disclosure. In particular, a processed video signal is presented, such as processed video signal 112, that includes a high resolution compressed video layer 112-1, and a low resolution compressed layer 112-2.

The high resolution compressed video layer 112-1, and low resolution compressed layer 112-2 are each independent video signals that include the same video content, but are, for example, mirror encoded to different video resolutions and formatted in a layered and synchronized fashion. A first portion of the video signal is encoded to include a low resolution portion a and a high resolution portion a′, similarly the next portion of the video signal is encoded to include a low resolution portion b and a high resolution portion b′, and so on. Each portion can include a single frame of video or a plurality of frames such as a group of pictures or other segment of video. In an embodiment, the processed video signal is packetized such that each packet contains one or more portions of the high resolution compressed video layer 112-1 along with all of the corresponding portions of the low resolution compressed layer 112-2. While, due to differences in resolution, the portions of the high resolution compressed video layer 112-1 contain more bits than the low resolution compressed layer 112-2, the layers are time-synchronized to allow more seamless and real-time switching between the two layers by a video player.

In the example show, a video player, such as video player 114, receives the processed video signal containing the high resolution compressed video layer 112-1, and the low resolution compressed layer 112-2. Both layers can be decoded but only one of the two layers is displayed at any given time. Before time t₁, the player stream 260 of the video player is in a low resolution playback mode. As a consequence, low resolution portions (a, b, . . . g) are played. At time t₁, the player stream 260 switches to high resolution playback and portions (h′, i′, j′, k′) are displayed. At time t₂, the player stream 260 switches back to low resolution playback and portions (L, m, n, . . . ) are displayed.

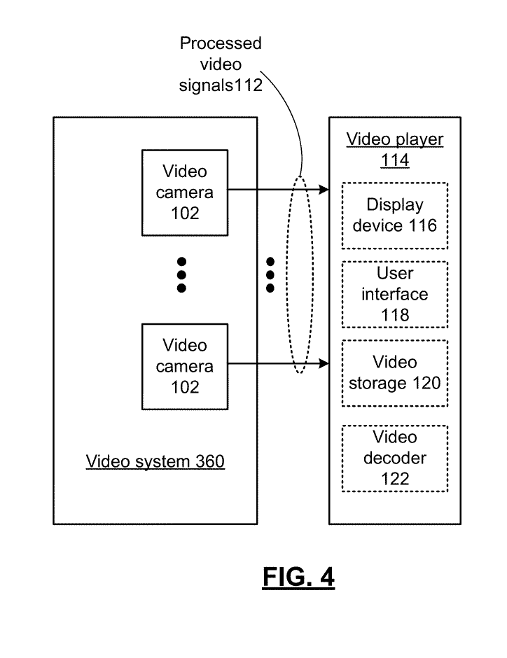

FIG. 4 presents a block diagram representation of a video system 360 in accordance with a further embodiment of the present disclosure. In particular, the video system 360 includes a plurality of video cameras 102 that generates a plurality of processed video signals 112, such as at differing vantage points of a common location, different feeds from different locations, different video programs, etc. The video player 114 selects from the high and low resolution layers of each of the processed video signals 112 for display by the display device 116. In one mode of operation, the video player generates a display screen that presents a mosaic of low resolution images, but each stream is selectable and can be switched in real time to a high resolution display of a single stream.

As discussed in conjunction with FIG. 2, a plurality of video cameras 102 can be placed around a vehicle. The low resolution images could be used for assembly into a so-called Bird's eye view, while the higher resolution version can recorded for storage and forensics, but can also be available to be switched to in real time with no delay when the low resolution is selected from the mosaic and that camera's video becomes the primary video for display.

Further, in video surveillance, home monitoring and security, the low resolution layer from a group of video cameras 102 can be used for transmission to a monitoring station and can be assembled in a mosaic for remote viewing. The high resolution layers can captured and stored for forensics, or later review, or even local viewing.

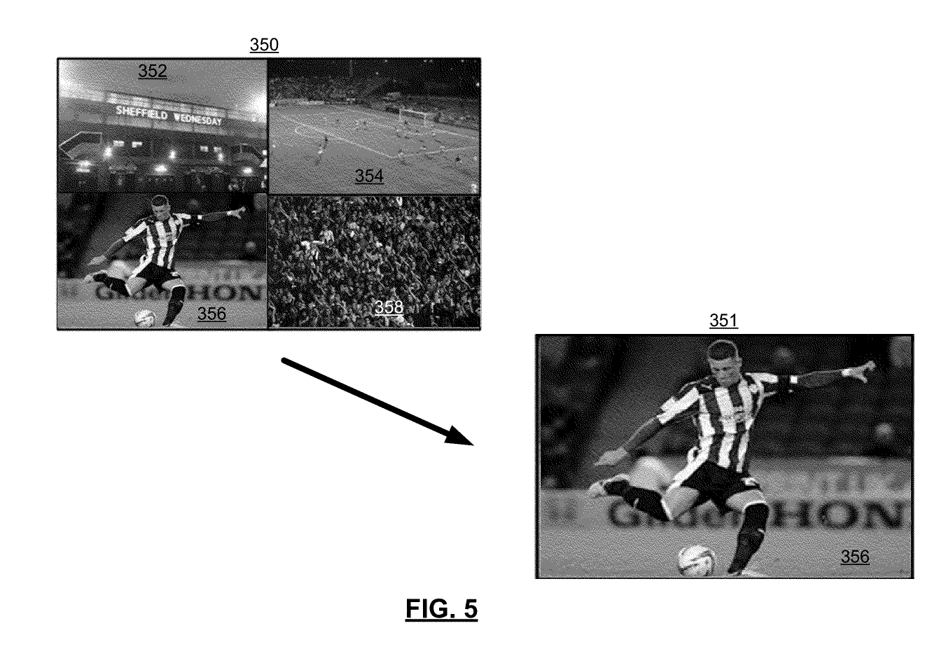

FIG. 5 presents a graphical diagram representation of a screen display in accordance with an embodiment of the present disclosure. In particular, a display screen 350, represents an example display screen presented by a video player, such as video player 114.

In the example shown, the video player receives four processed video signals representing four different views of a sporting event from four different video cameras of a video system 360. The low resolution compressed layer of each processed video signal is used to present a video mosaic where the multiple camera views 352, 354, 356 and 358 are shown together. The high resolution compressed layer versions of each processed video signal are instantly available for selection as the primary to view. In particular, when an exciting play happens in the view 356, the video player can operate under command of the viewer to switch to a display screen 351 that includes a full screen, high resolution display of the view 356.

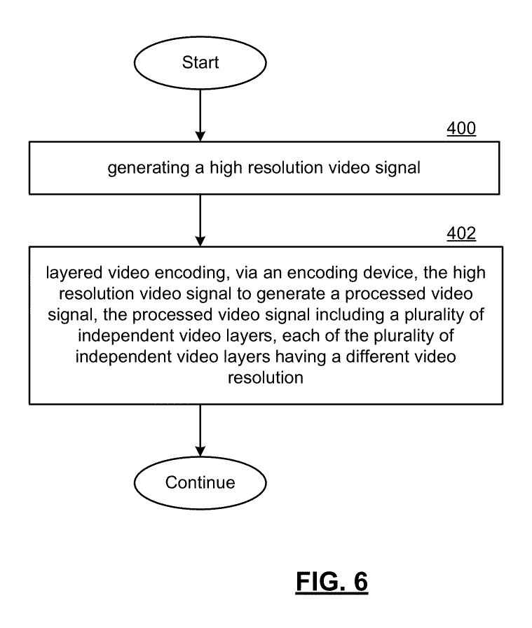

FIG. 6 presents a flowchart representation of a method in accordance with an embodiment of the present disclosure. In particular, a method is presented for use in conjunction with one or more functions and features presented in association with FIGS. 1-5. Step 400 includes generating a high resolution video signal. Step 402 includes layered video encoding, via an encoding device, the high resolution video signal to generate a processed video signal, the processed video signal including a plurality of independent video layers, each of the plurality of independent video layers having a different video resolution.

In an embodiment, the plurality of independent video layers are each compressed and are independently decodable without accessing any other one of each of the plurality of independent video layers. The plurality of independent video layers can include a 4K layer and at least one lower resolution layer. The plurality of video independent video layers are time synchronized to permit a video player to switch, in real time, between playback of a first layer of the plurality of independent video layers and playback of a second layer of the plurality of independent video layers.

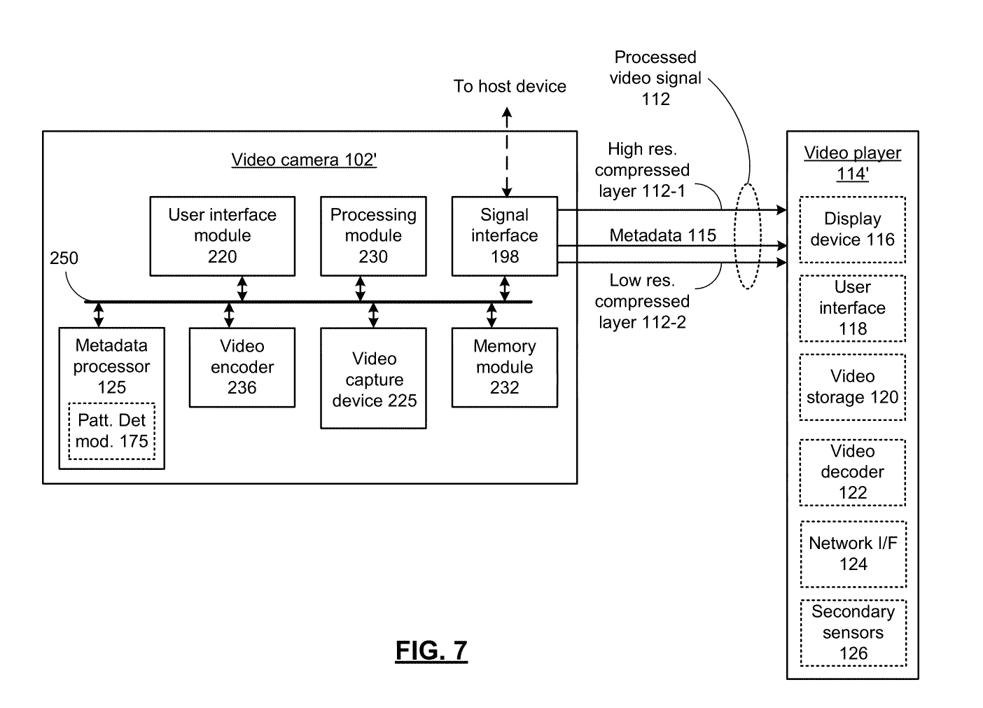

FIG. 7 presents a block diagram representation of a video camera 102′ in accordance with an embodiment of the present disclosure. In particular, a video camera 102′ and video camera 114′ are presented that includes many similar functions and features described in conjunction with FIG. 2 that are referred to by common reference numerals.

In this embodiment, the video player 114′ includes secondary sensors 126, such as audio sensors, thermal sensors, or other secondary sensors that are coupled to the video player 114 either directly or via optional network interface 124. The video camera 102′ includes a metadata processor 125. The metadata processor 125 operates based on the image sequence to generate metadata 115 and optionally pattern recognition feedback for transfer back to the video encoder 236 to aid in the encoding of the video signal from video capture device 225. In particular, metadata processor 125 includes a pattern detection module that can operate via clustering, statistical pattern recognition, syntactic pattern recognition or via other pattern detection algorithms or methodologies to detect or recognize a pattern in an image or image sequence (frame or field) of video signals 110, corresponding to an object of interest, a person of interest, a human activity and/or other objects. The metadata processor 125 in turn, generates metadata 115 and optionally pattern recognition feedback in response thereto.

In an embodiment, the metadata processor 125 analyzes the image stream from the video encoder in either high resolution or low resolution. For example, the metadata processor 125 can generate real-time analytics of the low quality video to detect gross happenings like movement or the presence of a known pattern, color combination etc. . . . and having that detection in turn trigger a switch to analysis of the video in the higher res stream (even when the lower res version might be the one still being displayed). Because the higher res stream contains more data, more accurate pattern, face, color recognition can be performed. The metadata processor 125 can further generate metadata 115 that includes markers in the processed video signal 112 that are time stamped or otherwise synchronized to indicate periods of interest based on pre-set criteria. Such markers can include real-time triggers to trigger the video player 114′ to change behaviour (switch to high res version, Zoom to full screen) automatically and without further user interaction based on the triggers in the content, level of interest etc. In addition, metadata 115 indicating periods of interest could also be used to trigger recording of the high res stream to capture the period of interest, to generate alerts, to trigger secondary sensors 124, such as thermal or sound, sensors to be activated—particularly in a surveillance environment. In particular, these advanced features can be supported, even where that video player 114 may not have its own analytics capabilities.

Consider an example where the video camera 102′ is used in conjunction with surveillance system at an event venue. Security personnel can monitor a tiled video display of low resolution images from multiple video cameras 102′ arranged at different locations. When metadata 115 generated by one of the video cameras 102′ indicates that a person appears to be engaged in an illicit activity at a particular locale, an alert can be automatically displayed in the display device, secondary sensors can be activated in proximity to the locale, the recording of high resolution video can be triggered as well as a switch in display mode to the high resolution display from the corresponding video camera 102′.

Consider a further example where the video camera 102′ is used in conjunction with a multi-feed broadcast of a sporting venue. Users can monitor a tiled video display of low resolution images from multiple video cameras 102′ of different feeds. When metadata 115 generated by one of the video cameras 102′ indicates that an exciting play is occurring, metadata 115 can be generated to trigger an automatic switch in display mode to a full screen high resolution display of the corresponding feed to capture the play. Referring back to the example presented in conjunction with FIG. 5, when the metadata processor detects that an exciting play is happening in the view 356 based on the recognition of a human activity responding to a major kick, the video player can operate under command of the metadata 115 to switch to a display screen 351 that includes a full screen, high resolution display of the view 356.

The video camera 102′ can generate the processed video signal 112 by combining the metadata 115 with the layers high resolution layers 112-1 and low resolution layers 112-2. This can be accomplished in several ways. In an embodiment the metadata 115 is time synchronized and presented on a separate metadata layer of processed video signal 112.

In another mode of operation, the video camera 102′ generates the processed video signal 112 by embedding the metadata 115 as a watermark on one or more layers of the processed video signal. In this fashion, the metadata 115 can be watermarked and embedded in time-coded locations, for example, that are relevant to a detected period of interest. The original video content can be decoded and viewed by legacy devices—however, the watermarking can be extracted and processed to utilize the metadata 115 with enhanced viewing devices 114′.

It should be noted that other techniques can be used by the video camera 102′ to combine the metadata 115 into the processed video signal 112. In another mode of operation, the metadata 115 can be encapsulated into a protocol that carries the audio and/or video portions of the processed video signal 112. The metadata 115 can be extracted by a video player 114′ by unwrapping the protocol and passing one or more layers of video packets to the video decoder 122 for separate decoding. Other techniques include interspersing or interleaving the metadata 115 with the layers of processed video signal 112, transmitting the metadata 115 in a separate layer such as an enhanced layer or other multi-layer formatted video layer, or transmitting the metadata 115 concurrently with the audio/video content of processed video signal 112 via time division multiplexing, frequency division multiplexing, code division multiplexing or other multiplexing technique.

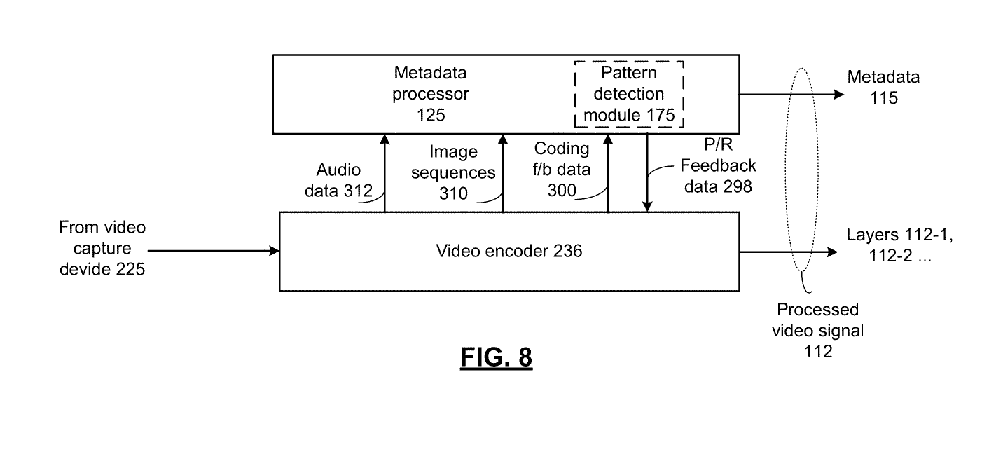

FIG. 8 presents a block diagram representation of a metadata processor 125 in accordance with an embodiment of the present disclosure. As previously discussed, the video encoder 236 generates a processed video signal 112 for storage and/or display based on the video signals from video capture device 225, generates an image sequence 310 and further generates coding feedback data 300. The coding feedback data 300 can include temporal or spatial encoding information, and/or color histogram data corresponding to a plurality of images in the image sequences 310. Video encoding/decoding and pattern recognition are both computational complex tasks, especially when performed on high resolution videos. Some temporal and spatial information, such as motion vectors and statistical information of blocks are useful for both tasks. So if the two tasks are developed together, they can share information and economize on the efforts needed to implement these tasks. In an embodiment, the metadata processor 125 recognizes the persons, objects and/or human activities based on the image data from the image sequences 310 and optionally based on the coding feedback data from the video encoder 236.

A pattern detection module 175 analyzes an image sequence 310 to search for objects, persons and/or activities of interest in the images of the image sequence based optionally on audio data 312, and coding feedback data 300. The pattern detection module 175 generates pattern recognition data that identifies objects, persons and/or activities of interest when present in one of the plurality of images along with the specific location of the objects, persons and/or activities of interest by image and by location within the image that can be used to generate corresponding metadata 115.

In an embodiment, the pattern detection module 175 tracks a candidate facial region over the plurality of images and detects a facial region based on an identification of facial features in the candidate facial region over the plurality of images. The facial features can include the identification, position and movement of various facial features including eyes; eyebrows, nose, cheek, jaw, mouth etc. In particular, face candidates can be validated for face detection based on the further recognition by pattern detection module 175 of facial features, like eye blinking (both eyes blink together, which discriminates face motion from others; the eyes are symmetrically positioned with a fixed separation, which provides a means to normalize the size and orientation of the head), shape, size, motion and relative position of face, eyebrows, eyes, nose, mouth, cheekbones and jaw. Any of these facial features can be used extracted from the image sequences 310 and used by pattern detection module 175 to eliminate false detections and further used by pattern detection module to determine an emotional state of a person. Further, the pattern detection module 175 can employ temporal recognition to extract three-dimensional features based on different facial perspectives included in the plurality of images to improve the accuracy of the recognition of the face and identification of the person. Using temporal information, the problems of face detection including poor lighting, partially covering, size and posture sensitivity can be partly solved based on such facial tracking. Furthermore, based on profile view from a range of viewing angles, more accurate and 3D features such as contour of eye sockets, nose and chin can be extracted.

In this mode of operation, the pattern detection module 175 generates pattern recognition data that can include an indication that human was detected, a location of the region of the human and pattern recognition data that includes, for example human action descriptors and correlates the human action to a corresponding video shot. The pattern detection module 175 can subdivide the process of human action recognition into: moving object detecting, human discriminating, tracking, action understanding and recognition. In particular, the pattern detection module 175 can identify a plurality of moving objects in the plurality of images. For example, motion objects can be partitioned from background. The pattern detection module 175 can then discriminate one or more humans from the plurality of moving objects. Human motion can be non-rigid and periodic. Shape-based features, including color and shape of face and head, width-height-ratio, limb positions and areas, tile angle of human body, distance between feet, projection and contour character, etc. can be employed to aid in this discrimination. These shape, color and/or motion features can be recognized as corresponding to human action via a classifier such as neural network. The action of the human can be tracked over the images in a sequence and a particular type of human action can be recognized in the plurality of images. Individuals, presented as a group of corners and edges etc., can be precisely tracked using algorithms such as model-based and active contour-based algorithm. Gross moving information can be achieved via a Kalman filter or other filter techniques. Based on the tracking information, action recognition can be implemented by Hidden Markov Model, dynamic Bayesian networks, syntactic approaches or via other pattern recognition algorithm.

In an embodiment, the pattern detection module 175 operates based on a classifier function that maps an input attribute vector, x=(x1, x2, x3, x4, . . . , xn), to a confidence that the input belongs to a class, that is, f(x)=confidence(class). The input attribute data can include a color histogram data, audio data, image statistics, motion vector data, other coding feedback data 300 and other attributes extracted from the image sequences 310. Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. This makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module.

It should be noted that classifier functions containing multiple different kinds of attribute data can provide a powerful approach to recognition. In one mode of operation, the pattern detection module 175 can recognize content that includes an object, based on color histogram data corresponding to colors of the object and sound data corresponding to a sound of the object and optionally other features. For example, a whisky bottle can be recognized based on a distinctive color histogram, a shape corresponding to the bottle, the sound of the whisky being opened or poured, and further based on text recognition of the bottle's box or label.

In another mode of operation, the pattern detection module 175 can recognize content that includes a person, based on color histogram data corresponding to colors of the person's face and sound data corresponding to a voice of the person. For example, color histogram data can be used to identify a region that contains a face, facial and speaker recognition can be used together to identify a person of interest. Metadata 115 can indicate a presence of persons and their emotional states, the identification of these persons along with profile data corresponding to these persons retrieved from an optional identification database, human activities associated with these persons, triggers that indicate recording, or display shift from high to low resolution and/or one or more alerts indicating suggested attention or action by surveillance personnel or other viewers, and/or other metadata.

In addition to searching for objects of interest, pattern recognition feedback 298 in the form of pattern recognition data or other feedback from the metadata processor 125 can be used to guide the encoding or transcoding performed by video encoder 236. After pattern recognition, more specific structural and statistically information can be generated as pattern recognition feedback 298 that can, for instance, guide mode decision and rate control to improve quality and performance in encoding of the video signal from video capture device 225. Metadata processor 125 can also generate pattern recognition feedback 298 that identifies regions with different characteristics. These more contextually correct and grouped motion vectors can improve quality and save bits for encoding, especially in low bit rate cases. After pattern recognition, estimated motion vectors can be grouped and processed in accordance with the pattern recognition feedback 298.

Pattern recognition feedback 298 can be used by video encoder 236 for bit allocation in different regions of an image or image sequence in encoding into processed video 112. In particular, facial regions and other objects of interest can be encoded with greater resolution or accuracy to aid in video surveillance or forensics. For example, when pattern recognition data from the pattern detection module 175 can indicate a face has been detected and the location of the facial region can also be used as pattern recognition feedback 298. The pattern recognition data can include facial characteristic data such as position in stream, shape, size and relative position of face, eyebrows, eyes, nose, mouth, cheekbones and jaw, skin texture and visual details of the skin (lines, patterns, and spots apparent in a person's skin), or even enhanced, normalized and compressed face images. In response, the video encoder 236 can guide the encoding of the image sequence based on the location of the facial region. In addition, pattern recognition feedback 298 that includes facial information can be used to guide mode selection and bit allocation during encoding. Further, the pattern recognition data and pattern recognition feedback 298 can further indicate the location of eyes or mouth in the facial region for use by the video encoder 236 to allocate greater resolution to these important facial features. For example, in very low bit rate cases the encoder section 236 can avoid the use of inter-mode coding in the region around blinking eyes and/or a talking mouth, allocating more encoding bits should to these face areas.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A video camera comprising:
a video capture device configured to produce a high resolution video signal; and
a video encoder configured to layered video encode the high resolution video signal to generate a processed video signal, the processed video signal including a plurality of independent video layers, each of the plurality of independent video layers having a different video resolution.

2. The video camera of claim 1 wherein the plurality of independent video layers are each compressed.

3. The video camera of claim 1 wherein each the plurality of independent video layers are independently decodable without accessing any other one of each of the plurality of independent video layers.

4. The video camera of claim 1 wherein the plurality of independent video layers include a 4K layer and at least one lower resolution layer.

5. The video camera of claim 1 wherein the plurality of independent video layers are time synchronized to permit a video player to switch, in real time, between playback of a first layer of the plurality of independent video layers and playback of a second layer of the plurality of independent video layers.

6. A video system comprising:
a plurality of video cameras that generates a plurality of processed video signals at differing vantage points of a common location, each video camera comprising:
a video capture device configured to produce a high resolution video signal; and
a video encoder configured to layered video encode the high resolution video signal to generate a corresponding one of the plurality of processed video signals, the plurality of processed video signals each including a plurality of independent video layers, each of the plurality of independent video layers having a different video resolution.

7. The video system of claim 6 wherein the plurality of independent video layers are each compressed.

8. The video system of claim 6 wherein each the plurality of independent video layers are independently decodable without accessing any other one of each of the plurality of independent video layers.

9. The video system of claim 6 wherein the plurality of independent video layers include a 4K layer and at least one lower resolution layer.

10. The video system of claim 6 wherein the plurality of independent video layers are time synchronized to permit a video player to switch, in real time, between playback of a first layer of the plurality of independent video layers and playback of a second layer of the plurality of independent video layers.

11. A method comprising:
generating a high resolution video signal; and
layered video encoding, via an encoding device, the high resolution video signal to generate a processed video signal, the processed video signal including a plurality of independent video layers, each of the plurality of independent video layers having a different video resolution.

12. The method of claim 11 wherein the plurality of independent video layers are each compressed.

13. The method of claim 11 wherein each the plurality of independent video layers are independently decodable without accessing any other one of each of the plurality of independent video layers.

14. The method of claim 11 wherein the plurality of independent video layers include a 4K layer and at least one lower resolution layer.

15. The method of claim 11 wherein the plurality of independent video layers are time synchronized to permit a video player to switch, in real time, between playback of a first layer of the plurality of independent video layers and playback of a second layer of the plurality of independent video layers.

16. The method of claim 11 further comprising:
analyzing at least one of, the high resolution video signal or a reduced resolution video signal generated for formatting as one of the plurality of independent layers, to generate metadata based on a recognition of an object, person or human activity.

17. The method of claim 16 wherein the metadata triggers a video player to automatically switch from a low resolution display of the processed video signal to a high resolution display of the processed video signal.
